(19) United States
(12) Patent Application Publication
(10) Pub. No.: US 2009/0283640 A1
(43) Pub. Date: Nov. 19, 2009

(54) ATTACHMENT SYSTEM AND METHOD

(75) Inventor: James E. Ebner, Lake Stevens, WA (US)

Correspondence Address: TUNG & ASSOCIATES / RANDY W. TUNG, ESQ., 838 W. LONG LAKE ROAD, SUITE 120, BLOOMFIELD HILLS, MI, 48302, US

(73) Assignee: The Boeing Company

(21) Appl. No.: 12/120,948

(22) Filed: May 15, 2008

(51) Int. Cl. B64C 1/00; F16D 1/00

(52) U.S. Cl. 244/131; 403/380

(57) ABSTRACT

An attachment system includes a dual sleeve nut comprising at least two spaced-apart nut housings; at least two interiorly-threaded fastener openings extending through the nut housings, respectively; and a nut base connecting the nut housings. At least two threaded fasteners extend through the fastener openings, respectively, of the nut housings. A method of attaching a bracket to a composite structure is also disclosed.

### TECHNICAL FIELD

The disclosure relates to techniques for attaching structural elements to each other. More particularly, the disclosure relates to an attachment system and method which are particularly suitable for attaching hardware or systems supports to a composite structure.

### BACKGROUND

Conventional methods of attaching hardware and systems supports to a composite structure may require the use of either removable fasteners (bolts) or permanent hi-lock style fasteners (bolts) to attach a support bracket to the composite structure. The fasteners may each have a smooth shaft with a threaded portion. Using this approach, an installer may need to ensure that the smooth shaft portion of each fastener extends beyond the stack-up between the support bracket and the composite structure. In some cases, depending on the combination of fasteners used and fastener length, an additional washer may be required to ensure that no threads are in bearing common to the fastener openings in the support bracket and composite structure and to ensure that the fastener can be torqued as required. If removable fasteners are used, installation may require that a driver and a wrench be positioned on opposite sides of the assembly to torque the fastener and prevent rotation of the nut on the fastener, respectively.

Utilization of hi-lock style fasteners may allow torquing from one side of the structure but require a special hi-lock wrench tool. Regardless of the fastener used, the existing method may take longer to gather the proper hardware for various structure gages. Furthermore, the existing method may render it easier to drop the hardware during installation and may require more parts for installation.

Composite structures throughout an airplane may vary in gauge due to weight efficiency initiatives which may gauge the structure up only where needed to support load paths. This may render difficulty in using shanked bolts using the traditional method of attaching hardware and systems supports to a composite structure. Much time may be necessary to ensure that the varying stack-ups of the components were accounted for in the specific fastener length call out and washer stack-up in both design and manufacturing processes.

### SUMMARY

The disclosure is generally directed to an attachment system. An illustrative embodiment of the attachment system includes a dual sleeve nut comprising at least two spaced-apart nut housings; at least two interiorly-threaded fastener openings extending through the nut housings, respectively; a sleeve extending from the base of the nut housing and a nut base connecting the nut housings. At least two threaded fasteners extend through the fastener openings, respectively, of the nut housings.

The disclosure is further generally directed to a method of attaching a bracket or system support to a composite structure. An illustrative embodiment of the method includes providing a dual sleeve nut comprising spaced-apart nut housings, a nut base connecting the nut housings, nut sleeves extending from the nut housings, respectively, and interiorly-threaded fastener openings extending through the nut housings and the nut sleeves, respectively; providing a composite structure having at least two fastener openings; providing a bracket having at least two fastener openings; inserting the nut sleeves of the dual sleeve nut through the fastener openings, respectively, of the composite structure; providing at least two threaded fasteners; and inserting the threaded fasteners through the fastener openings of the bracket, through the sleeves of the dual sleeve nut and threading the threaded fasteners in the interiorly-threaded fastener openings in the nut housings, respectively, of the dual sleeve nut.

### BRIEF DESCRIPTION OF THE ILLUSTRATIONS

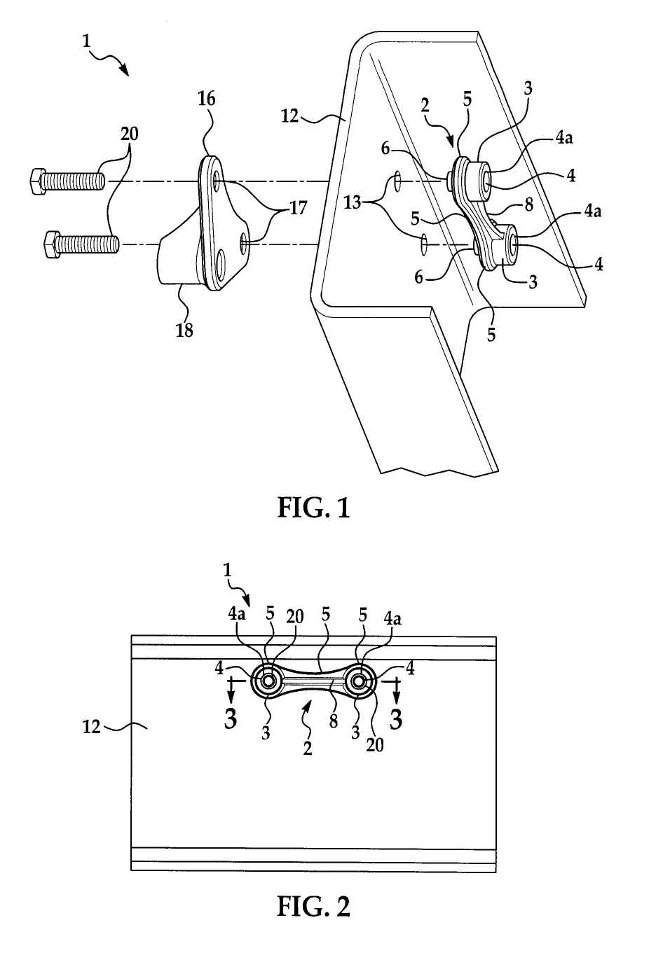

FIG. 1 is an exploded perspective view of an illustrative embodiment of the attachment system in attachment of a bracket to a composite structure.

FIG. 2 is a top view of an illustrative embodiment of the attachment system attaching a bracket (not shown) to a composite structure.

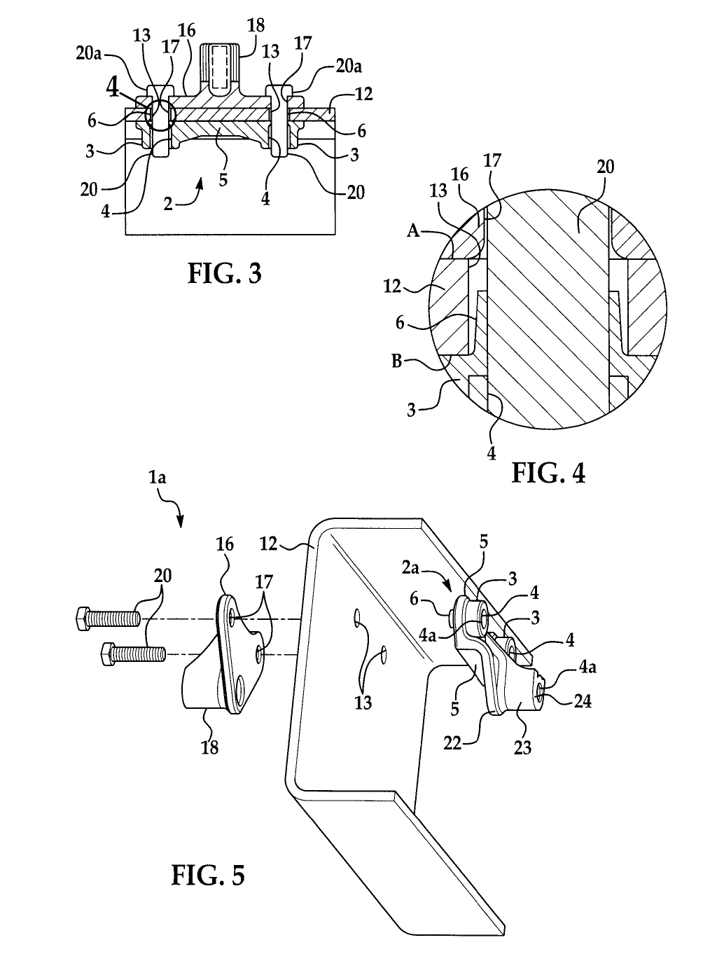

FIG. 3 is a sectional view, taken along section lines 3-3 in FIG. 2.

FIG. 4 is an enlarged sectional view, taken from view 4 in FIG. 3.

FIG. 5 is an exploded perspective view of an alternative illustrative embodiment of the attachment system in attachment of a bracket to a composite structure.

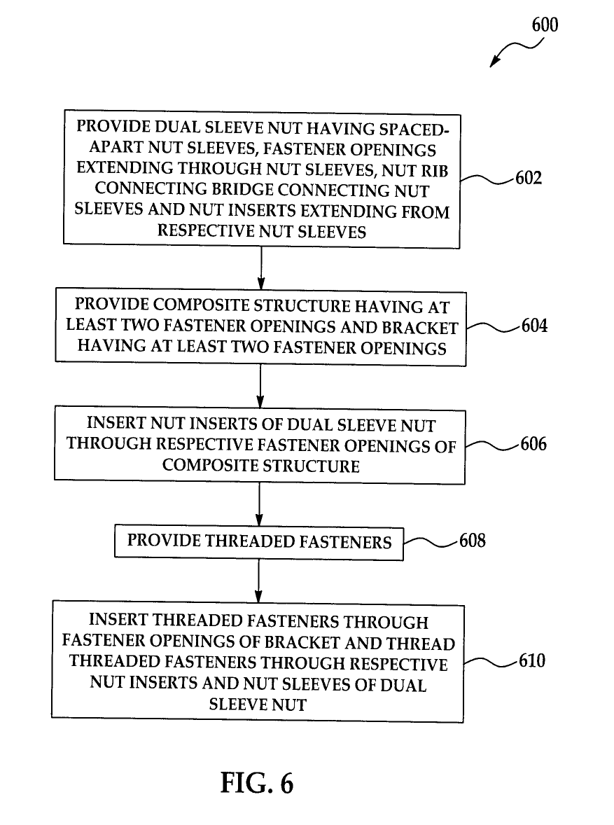

FIG. 6 is a flow diagram of an illustrative embodiment of an attachment method.

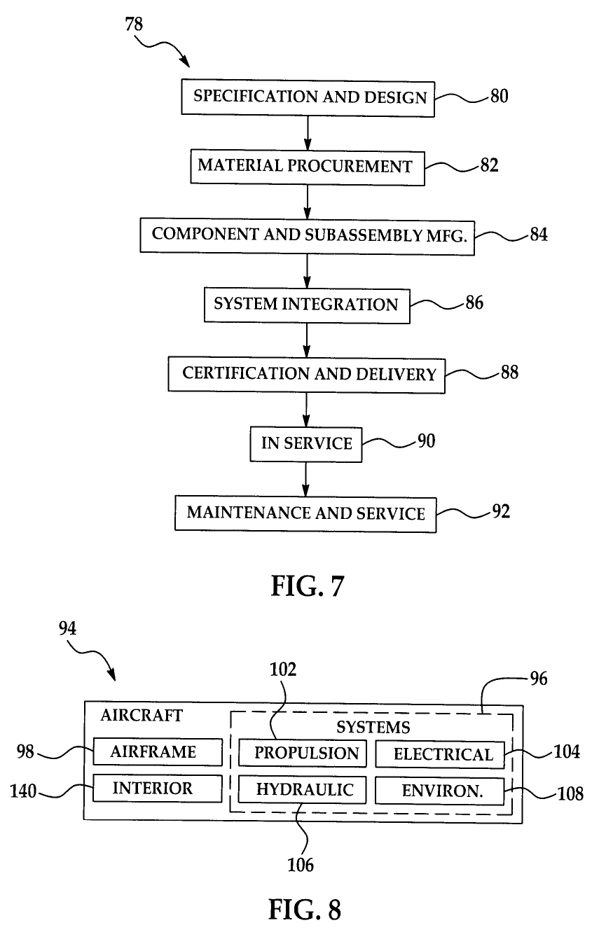

FIG. 7 is a flow diagram of an aircraft production and service methodology.

FIG. 8 is a block diagram of an aircraft.

### DETAILED DESCRIPTION

Referring initially to FIGS. 1-4, an illustrative embodiment of the attachment system is generally indicated by reference numeral 1. The attachment system 1 may be adapted to secure hardware or system supports such as a bracket 16, for example and without limitation, to a composite structure 12. The bracket 16 may include at least two spaced-apart fastener openings 17 for attachment of the bracket 16 to the composite structure 12 as will be hereinafter described. The bracket 16 may further include a bracket boss 18 for attachment of a sub-structure or system component( not shown) to the bracket 16. The composite structure 12 may include at least two spaced-apart fastener openings 13 for attachment of the bracket 16 to the composite structure 12 as will be hereinafter described.

The attachment system 1 may include a generally elongated dual sleeve nut 2 which may be a single monolithic piece and may be a thermoplastic or composite material. The dual sleeve nut 2 may include at least two spaced-apart, generally cylindrical nut housings 3, each having an fastener opening 4 which further extend through each corresponding nut sleeve 6. A threaded insert 4a may be provided in the insert opening 4. A nut base 5 may connect the nut housings 3. As shown in FIGS. 1 and 2, a reinforcing rib 8 may extend along the nut base 5 for reinforcing purposes.

As shown in FIGS. 1 and 2, a nut sleeve 6 may extend from each nut housing 3 in concentric relationship with respect to the insert opening 4 of each, which fastener opening 4 extends through the corresponding nut sleeve 6. The nut sleeves 6 may facilitate indexing of the dual sleeve nut 2 with respect to the fastener openings 13 in the composite structure 12 which simplifies the installation of bracket 16 as will be hereinafter described. The attachment system 1 may further include at least two threaded fasteners 20 which may be extended through the fastener openings 17 of the bracket 16 and the fastener openings 13 of the composite structure 12 and threaded through the threaded inserts 4a in the fastener openings 4 in the respective nut housings 3 and nut sleeves 6 of the dual sleeve nut 2 to fasten the bracket 16 to the composite structure 12.

In typical application, the attachment system 1 attaches the bracket 16 to the composite structure 12. Accordingly, the bracket 16 may be placed against a first surface A of the composite structure 12 with the fastener openings 17 in the bracket 16 disposed in alignment with the respective fastener openings 13 in the composite structure 12. The nut sleeves 6 of the dual sleeve nut 2 may be inserted through the respective fastener openings 13 in the composite structure 12, as shown in FIG. 4, as the nut base 5 of the dual sleeve nut 2 engages the opposite or second surface B of the composite structure 12. Next, the fasteners 20 may be inserted through the respective fastener openings 17 of the bracket 16 and corresponding nut sleeves 6 of the dual sleeve nut 2 and threaded through the inserts 4a of the fastener openings 4 which extend through the respective nut housings 3 of the dual sleeve nut 2, as further shown in FIG. 4. The fastener head 20a of each fastener 20 may engage the bracket 16, as shown in FIG. 3.

It will be appreciated by those skilled in the art that the nut sleeves 6 of the dual sleeve nut 2 may seal off the composite structure 12 and protect the composite structure 12 from the threads of the respective threaded fasteners 20. Each nut sleeve 6 may also provide indexing common to the fastener openings 13 in the composite structure 12 which aide in holding in place during installation. The nut sleeves 6, in combination with the nut base 5 and the reinforcing rib 8 of the dual sleeve nut 2, also provides an anti-rotation feature that provides a shop aide for torquing of the fasteners 20 during installation of the bracket 16 on the opposite surface of the composite structure 12. Installation of the dual sleeve nut 2 may allow the installer to torque the fasteners 20 from one side of the composite structure 12 using standard tools (such as a nut driver or socket wrench, for example and without limitation).

The attachment system 1 may enable an installer to torque the fasteners 20 without having to secure the dual sleeve nut 2 with a wrench such as must be done for a conventional method with a standard nut. Furthermore, the attachment system 1 may protect and seal the composite structure 12 from full-threaded fasteners 20 and incompatible metallic materials and finishes. The attachment system 1 may provide fewer parts in the assembly process and reduce the possibility of dropping and losing parts during the installation.

Referring next to FIG. 5 of the drawings, an alternative illustrative embodiment of an attachment system is generally indicated by reference numeral 1a. The attachment system 1a includes an offset-systems support type dual sleeve nut 2a. The dual sleeve nut 2a may include a nut flange 22 which extends from the nut base 5. A nut boss 23, having an interiorly-threaded fastener opening 24, may extend from the nut flange 22 to facilitate attachment of sub-structure or system component(not shown) to the dual sleeve nut 2a. The dual sleeve nut 2a may be attached to the composite structure 12 in the same manner as was heretofore described with respect to FIGS. 1-4 in attachment of the dual sleeve nut 2 to the composite structure 12.

Referring next to FIG. 6, a flow diagram 600 of an illustrative embodiment of an attachment method is shown. In block 602, a dual sleeve nut having spaced-apart nut sleeves; fastener openings extending through the nut sleeves and threaded inserts; a base and rib connecting the nut sleeves; and nut inserts extending from the respective nut sleeves is provided. In block 604, a composite structure having at least two fastener openings and a bracket having at least two fastener openings is provided. In block 606, the nut inserts of the dual sleeve nut are inserted through the respective fastener openings of the composite structure. In block 608, threaded fasteners are provided. In block 610, the threaded fasteners are inserted through the fastener openings of the bracket and threaded through the respective nut inserts and nut sleeves of the dual sleeve nut.

Referring next to FIGS. 7 and 8, embodiments of the disclosure may be used in the context of an aircraft manufacturing and service method 78 as shown in FIG. 7 and an aircraft 94 as shown in FIG. 8. During pre-production, exemplary method 78 may include specification and design 80 of the aircraft 94 and material procurement 82. During production, component and subassembly manufacturing 84 and system integration 86 of the aircraft 94 takes place. Thereafter, the aircraft 94 may go through certification and delivery 88 in order to be placed in service 90. While in service by a customer, the aircraft 94 may be scheduled for routine maintenance and service 92 (which may also include modification, reconfiguration, refurbishment, and so on).

Each of the processes of method 78 may be performed or carried out by a system integrator, a third party, and/or an operator (e.g., a customer). For the purposes of this description, a system integrator may include without limitation any number of aircraft manufacturers and major-system subcontractors; a third party may include without limitation any number of vendors, subcontractors, and suppliers; and an operator may be an airline, leasing company, military entity, service organization, and so on.

As shown in FIG. 8, the aircraft 94 produced by exemplary method 78 may include an airframe 98 with a plurality of systems 96 and an interior 100. Examples of high-level systems 96 include one or more of a propulsion system 102, an electrical system 104, a hydraulic system 106, and an environmental system 108. Any number of other systems may be included. Although an aerospace example is shown, the principles of the invention may be applied to other industries, such as the automotive or marine industry.

The apparatus embodied herein may be employed during any one or more of the stages of the production and service method 78. For example, components or subassemblies corresponding to production process 84 may be fabricated or manufactured in a manner similar to components or subassemblies produced while the aircraft 94 is in service. Also, one or more apparatus embodiments may be utilized during the production stages 84 and 86, for example, by substantially expediting assembly of or reducing the cost of an aircraft 94. Similarly, one or more apparatus embodiments may be utilized while the aircraft 94 is in service, for example and without limitation, to maintenance and service 92.

Although the embodiments of this disclosure have been described with respect to certain exemplary embodiments, it is to be understood that the specific embodiments are for purposes of illustration and not limitation, as other variations will occur to those of skill in the art.

What is claimed is:

1. An attachment system, comprising:
a dual sleeve nut comprising:
at least two spaced-apart nut housings;
at least two fastener openings extending through said nut housings, respectively; and
a nut base connecting said nut housings; and
at least two threaded fasteners extending through said fastener openings, respectively, of said nut housings.

2. The attachment system of claim 1 further comprising a pair of threaded inserts provided in said fastener openings, respectively, and wherein said threaded fasteners extend through said threaded inserts, respectively.

3. The attachment system of claim 1 further comprising at least two nut sleeves extending from said nut base, respectively, and wherein said fastener openings extend through said nut sleeves, respectively.

4. The attachment system of claim 1 further comprising a reinforcing rib extending along said nut base.

5. The attachment system of claim 1 wherein said dual sleeve nut comprises a thermoplastic or composite material.

6. The attachment system of claim 1 wherein said dual sleeve nut is monolithic.

7. The attachment system of claim 1 wherein said at least two spaced-apart nut housings comprises two nut housings, said at least two interiorly-threaded fastener openings comprises two interiorly-threaded fastener openings and said at least two threaded fasteners comprises two threaded fasteners.

8. The attachment system of claim 1 further comprising a nut flange extending from said nut base and a nut boss having a fastener opening extending from said nut flange.

9. An attachment system, comprising:
a composite structure having at least two fastener openings;
a bracket having at least two fastener openings disposed in registering relationship with respect to said fastener openings, respectively, of said composite structure;
a dual sleeve nut comprising:
at least two spaced-apart nut housings;
at least two interiorly-threaded fastener openings extending through said nut housings, respectively, and disposed in registering relationship with respect to said fastener openings, respectively, of said composite structure; and
a nut base connecting said nut housings; and
at least two threaded fasteners extending through said fastener openings, respectively, of said bracket and said fastener openings, respectively, of said composite structure and threaded in said interiorly-threaded fastener openings, respectively, of said nut housings of said dual sleeve nut.

10. The attachment system of claim 9 further comprising a pair of threaded inserts provided in said fastener openings, respectively, and wherein said threaded fasteners extend through said threaded inserts, respectively.

11. The attachment system of claim 9 further comprising at least two nut sleeves extending from said nut housings, respectively, and through said fastener openings of said composite structure and wherein said threaded fasteners extend through said nut sleeves, respectively.

12. The attachment system of claim 9 further comprising a reinforcing rib extending along said nut base.

13. The attachment system of claim 9 wherein said dual sleeve nut comprises a thermoplastic or composite material.

14. The attachment system of claim 9 wherein said dual sleeve nut is monolithic.

15. The attachment system of claim 9 wherein said composite structure having at least two fastener openings comprises a composite structure having two fastener openings, said bracket having at least two fastener openings comprises a bracket having three fastener openings, said at least two spaced-apart nut housings comprises two nut housings, said at least two interiorly-threaded fastener openings comprises two interiorly-threaded fastener openings and said at least two threaded fasteners comprises three threaded fasteners.

16. The attachment system of claim 9 further comprising a nut flange extending from said nut base and a nut boss having a fastener opening extending from said nut flange.

17. A method of attaching a bracket to a composite structure, comprising:
providing a dual sleeve nut comprising spaced-apart nut housings, a nut base connecting said nut housings, nut sleeves extending from said nut housings, respectively, and interiorly-threaded fastener openings extending through said nut housings and said nut sleeves, respectively;
providing a composite structure having at least two fastener openings;
providing a bracket having at least two fastener openings;
inserting said nut sleeves of said dual sleeve nut through said fastener openings, respectively, of said composite structure;
providing at least two threaded fasteners; and
inserting said threaded fasteners through said fastener openings of said bracket and sleeves of the dual sleeve nut and threading said threaded fasteners in said interiorly-threaded fastener openings in said nut housings respectively, of said dual sleeve nut.

18. The method of claim 17 further comprising extending a reinforcing rib from said nut base.

19. The method of claim 17 wherein said providing a dual sleeve nut comprises providing a monolithic dual sleeve nut.

20. The method of claim 17 wherein said providing a dual sleeve nut comprises providing a dual sleeve nut comprising a thermoplastic or composite material.
